(19) United States
(12) Patent Application Publication
(10) Pub. No.: US 2017/0224011 A1
(43) Pub. Date: Aug. 10, 2017

(54) ROLLING BOX APPARATUS

(71) Applicant: Dimitri SHEVTSOV, Jerusalem (IL)

(72) Inventor: Dimitri SHEVTSOV, Jerusalem (IL)

(21) Appl. No.: 15/421,445

(22) Filed: Feb. 1, 2017

(30) Foreign Application Priority Data
Feb. 9, 2016 (IL) 244057

(51) Int. Cl. A24C 5/44; F21V 23/00; F21V 33/00; F21V 23/04; H01M 2/10; F21S 9/02

(52) U.S. Cl. CPC A24C 5/44; H01M 2/1044; F21S 9/02; F21V 33/008; F21V 23/04; F21V 23/001; H01M 2220/30; F21Y 2115/10

(57) ABSTRACT

In one aspect, the present invention is directed to a rolling box apparatus, comprising: a cover (12) pivotally connected to a box (10) thereof by a pivot (42); a strap (16), for rolling a cigarette; a LED (20), for illuminating the strap; a battery (44), for providing power to the LED; a circuit (46), for connecting the LED (20) to the battery (44); the circuit (46) comprising a switch (22) activated by the cover (12), for closing the circuit upon opening the cover (12), and opening the circuit upon closing the cover; thereby illuminating the strap upon rolling a cigarette.

### TECHNICAL FIELD

The present invention relates to the field of smoking accessories. More particularly, the invention relates to a rolling box for cigarettes and joints.

### BACKGROUND ART

As a result of the rising cost of cigarettes, many smokers prefer to produce cigarettes by themselves. A popular means for producing a cigarette is called a “rolling box”.

FIG. 1 schematically illustrates a rolling box apparatus in its closed state, according to the prior art.

FIG. 2 schematically illustrates the rolling box apparatus of FIG. 1, in its open state, according to the prior art.

The rolling box apparatus is marked herein by reference numeral 100. The size thereof is about 8×9×2 cm, i.e., approximately the size of a man's wallet.

The rolling box is used for storing tobacco, filters and cigarette papers (not illustrated in the figures). Upon opening the rolling box, a strap 16 is exposed. The lower portion of the strap can be expanded, for generating a pouch. In this situation, the pouch is filled with tobacco 32 and a filter 34 is placed therein. Then, a piece of rolling paper is placed behind the material, against the strap, with the gummed side at the top and facing outwards.

As the cover 12 is slowly closed, an arm 40 lifts the pouch pointed by arrow 36 up, forming a cigarette, joint, and the like.

The cover 12 is pivotally connected to box 10 by a pivot 42. When the closing motion is complete, the rolled cigarette is ejected through opening 14 in the top of the cover 12.

The rolling process is cumbersome, and is carried out in a wallet sized box. As such, in order to roll a cigarette appropriate visibility is required. Such conditions are not always available, especially if the user is in a pub, where the visibility is obscure deliberately.

It is an object of the invention to provide a satisfactory solution to the above mentioned problems.

Other objects and advantages of the invention will become apparent as the description proceeds.

### SUMMARY OF THE INVENTION

In one aspect, the present invention is directed to a rolling box apparatus, comprising:
a cover (12) pivotally connected to a box (10) thereof by a pivot (42);
a strap (16), for rolling a cigarette;
a LED (20), for illuminating the strap;
a battery (44), for providing power to the LED;
a circuit (46), for connecting the LED (20) to the battery (44);
the circuit (46) comprising a switch (22) activated by the cover (12), for closing the circuit upon opening the cover (12), and opening the circuit upon closing the cover;

thereby illuminating the strap upon rolling a cigarette.

According to one embodiment of the invention, the LED (20) is installed at an edge of the cover, opposite to the pivot (42), in an interior side of the cover, thereby allowing illuminating the strap.

The battery may be chargeable, for example, by a USB interface.

According to one embodiment of the invention, the circuit (46) is adapted to retain provision of electric power to the LED for a limited period of minutes.

In another aspect, the present invention is directed to a rolling box apparatus, comprising:
a cover (12) pivotally connected to a box (10) thereof by a pivot (42);
a strap (16), for rolling a cigarette;
a illuminating fixture (20), for illuminating the strap;
an electric power source (44), for providing electric power to the illuminating fixture (20);
a circuit (46), for connecting the illuminating fixture (20) to the power source (44);
wherein the circuit comprises a switch (22) activated by the cover (12), for closing the circuit upon opening the cover (12), and opening the circuit upon closing the cover;

thereby illuminating the strap upon rolling a cigarette.

According to one embodiment of the invention, the illuminating fixture (20) is installed at an edge of the cover, opposite to the pivot (42), in an interior side of the cover, thereby allowing illuminating the strap. Preferably, the illuminating fixture is a LED.

According to one embodiment of the invention, the power source is a battery.

According to one embodiment of the invention, the power source is chargeable, e.g., by a USB interface.

In yet another aspect, the present invention is directed to a rolling box apparatus, comprising:
a cover (12);
a box (10);
a strap (16), for rolling a cigarette;
a illuminating fixture (20), for illuminating the strap;
an electric power source (44), for providing electric power to the illuminating fixture (20);
a circuit (46), for connecting the illuminating fixture (20) to the power source (44);
wherein the circuit comprising a button (48) for activating the circuit to provide electric power to the illuminating fixture;

thereby illuminating the strap upon rolling a cigarette.

According to one embodiment of the invention, the circuit is adapted to retain the power provision for a determined period.

According to one embodiment of the invention, the button opens the cover.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF DRAWINGS

Preferred embodiments, features, aspects and advantages of the present invention are described herein in conjunction with the following drawings:

FIG. 1 schematically illustrates a rolling box apparatus in its closed state, according to the prior art.

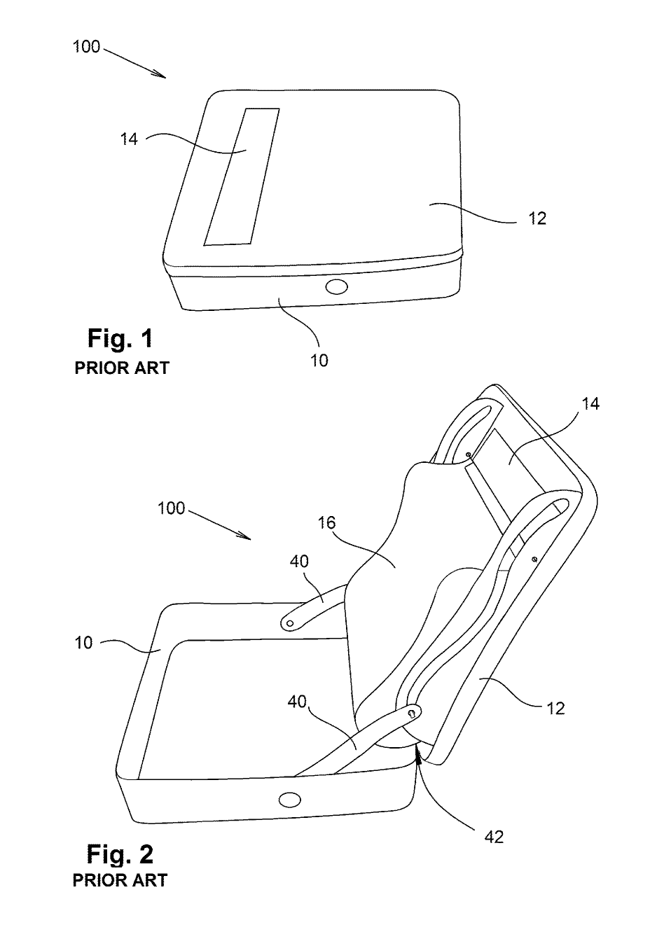

FIG. 2 schematically illustrates the rolling box apparatus of FIG. 1, in its open state, according to the prior art.

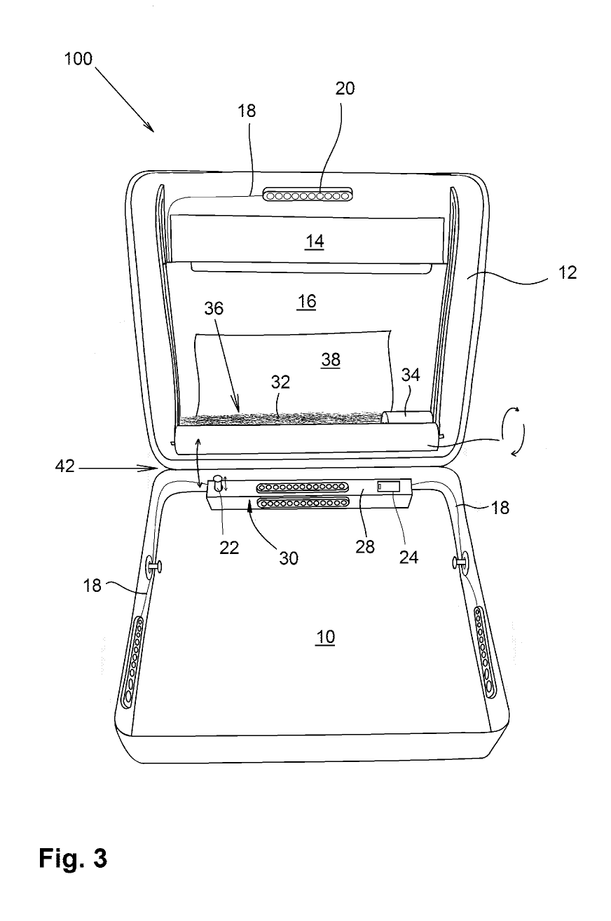

FIG. 3 is a front view of a rolling box apparatus, according to one embodiment of the invention, and FIG. 4 is a side view thereof.

FIG. 5 is a front view of an open rolling box apparatus, according to a preferred embodiment of the invention, and FIG. 6 is a side view thereof.

FIG. 7 schematically illustrates a closed rolling box apparatus, according to one embodiment of the invention.

FIG. 8 schematically illustrates an electric circuit of a rolling box, according to one embodiment of the invention.

It should be understood that the drawings are not necessarily drawn to scale.

### DESCRIPTION OF EMBODIMENTS

The present invention will be understood from the following detailed description of preferred embodiments (“best mode”), which are meant to be descriptive and not limiting. For the sake of brevity, some well-known features, methods, systems, procedures, components, circuits, and so on, are not described in detail.

The invention solves the visibility problem described above by installing inside the rolling box one or more LEDs (Light Emitting Diode). Each of the LEDs is marked herein by reference numeral 20. A switch 22 is installed in such a way that upon opening the cover 12 of box 10, the switch closes a circuit which provides electric power to the LEDs, and the LEDs illuminate the internal side of the box. In this way, the internal side of the box is illuminated, and therefore provides to a user thereof proper visibility for the rolling process.

Since the electric power consumed by a LED is relatively small, and since the time the box is open is relatively short, the total power consumption in a time period is negligible, and as such a battery such as is used in watches may hold a relatively long period, such as months or even a year.

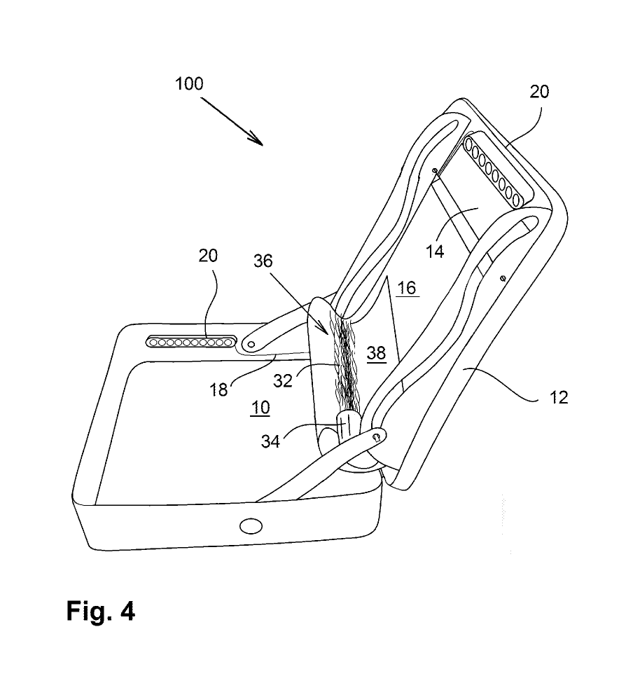

FIG. 3 is a front view of a rolling box apparatus, according to one embodiment of the invention, and FIG. 4 is a side view thereof.

These figures also illustrate the way the cigarette ingredients are placed in the rolling box: Arrow 36 points on a pouch generated by folding strap 16. In the pouch are placed tobacco 32 and a filter 34. Also is disposed in the pouch cigarette paper 38. Upon closing the cover 12, the rolling process is carried out, and on its termination a rolled cigarette or joint is ejected from opening 14.

According to this embodiment of the invention, a plurality of LEDs 20 are installed, one on the cover 12, one on the left side of the box, one on the right side of the box, and one near the pivot 42 that connects the cover 12 to the box 10.

Actually, one LED is adequate; however the illustration shows some locations possibilities in which a LED may be placed.

Reference numeral 30 denotes a illuminating assembly which comprises a casing 28 in which is installed a LED 20, a switch 22, a battery 24, and an electrical circuit (not seen). The illuminating assembly 30 comprises a circuit which disconnects the LED from the battery when the switch is pushed down (i.e., when the box 10 is closed), and connects the LED to the battery when box 10 opens (i.e., when the cover 12 is lifted). Other LEDs are connected to illuminating assembly 30 by wires 18.

Since illuminating assembly 30 comprises the essential elements of the illuminating mechanism, i.e., a LED, a switch, and a battery, when the illuminating assembly is placed in a location where the LED can illuminate the pocket, no additional LEDs are required.

As such, instead of placing the LEDs apart from the battery and connecting the battery to the LED by wires, illuminating assembly 30 can be glued or welded to the box 10, which is a simple manufacturing act. Furthermore, a user may glue the assembly by himself, and therefore the illuminating assembly can be distributed separately from the rolling box apparatus 100.

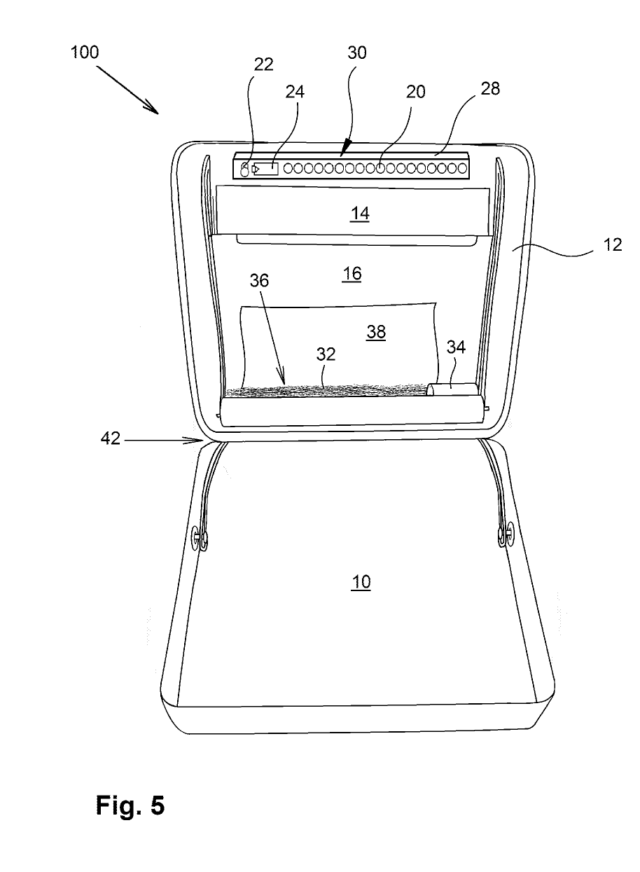

FIG. 5 is a front view of an open rolling box apparatus, according to a preferred embodiment of the invention, and FIG. 6 is a side view thereof.

As illustrated, illuminating assembly 30 is disposed at the inner side of cover 12, at the edge opposite to pivot 42 which connects the cover 12 with the box 10.

In this way, the illuminating fixture lights the pouch pointed by arrow 36 from above, thereby allowing seeing the region of the apparatus at which the user puts the tobacco, cigarette paper and filter.

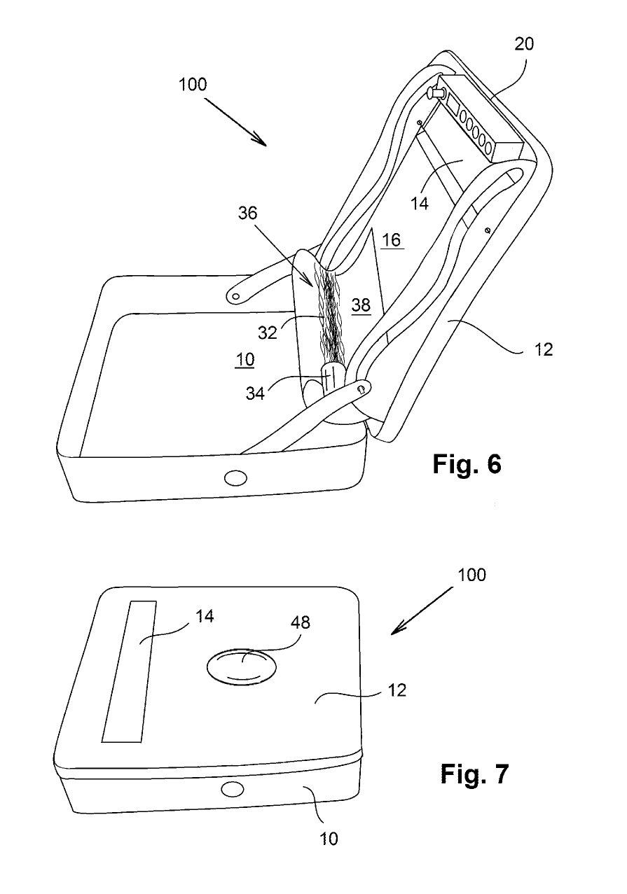

FIG. 7 schematically illustrates a closed rolling box apparatus, according to one embodiment of the invention.

A button 48 is disposed at the outer side of cover 12. The button activates the power provision to the illuminating fixture (not seen), for a determined period, e.g. 1 minute.

In this way, a user can push the button to turn on the illuminating fixture for a determined period, and while the light fixture is turned on, he can open the box and roll a cigarette.

According to a further embodiment of the invention, the bottom also opens the box, i.e., lifts the side of the cover 12, at the side opposite to the pivot that pivotally connects the cover with the box. Such a mechanism may use a spring (not illustrated) that pushes the cover to its open state, and a hook (not illustrated as well) which keeps the cover closed. Upon pressing the button the hook moves, thereby allowing the spring to open the cover.

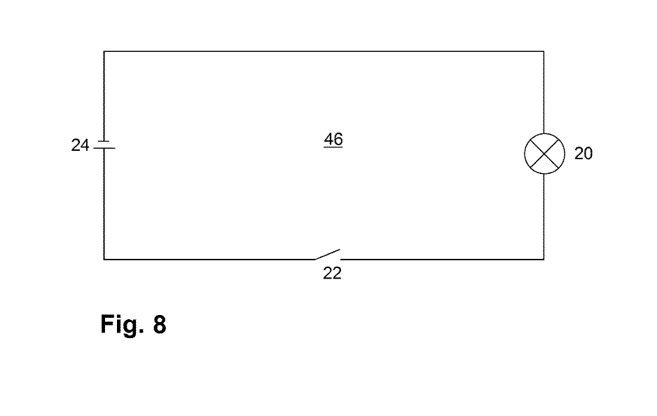

FIG. 8 schematically illustrates an electric circuit of a rolling box, according to one embodiment of the invention.

The electric circuit, which is marked herein by reference numeral 46, comprises a power source 24, for providing electric power to a light fixture 20. The electric power provision depends on the state of switch 22: when switch 22 is closed, light fixture 20 is provided with electric power; when switch 22 is open, light fixture 20 is not provided with electric power.

The light fixture 20 is preferably a LED; however, it can be any other illumination facility, such as a filament bulb.

The power source 24 may be a battery, which may be chargeable, e.g., by a USB (Universal Serial Bus) interface.

Using one or more LEDs as a illuminating fixture is considered by the Applicant as the best mode due to its relatively low electric power consumption and its high illumination ability, other illuminating fixtures may also be used, such as a filament bulb.

According to one embodiment of the invention, the battery is chargeable, thereby prolonging the lifetime of the rolling box apparatus.

In the figures and/or description herein, the following reference numerals (Reference Signs List) have been mentioned:
numeral 100 denotes a rolling box apparatus;
numeral 10 denotes a box;
numeral 12 denotes a cover of the box;
numeral 14 denotes a dispensing opening;
numeral 16 denotes a strap;
numeral 18 denotes an electric wire;
numeral 20 denotes a LED, as an example of illuminating fixture;
numeral 22 denotes a switch;
numeral 24 denotes a battery, as an example of an electric power source;
numeral 28 denotes a casing of illuminating assembly 30;
numeral 30 denotes a illuminating assembly;
numeral 32 denotes tobacco;
numeral 34 denotes a cigarette filter;
numeral 36 denotes an arrow pointing on a pouch;
numeral 38 denotes cigarette paper;
numeral 40 denotes an arm;
numeral 42 a pivot;
numeral denotes a battery, as an example of an electric power source;
numeral 46 denotes an electric circuit; and
numeral 48 denotes a button.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1. A rolling box apparatus (100), comprising:
a handheld cover (12) pivotally connected to a box (10) thereof by a pivot (42);
a strap (16), for rolling a cigarette;
a LED (20), for illuminating said strap;
a battery (44), for providing power to said LED;
a circuit (46), for connecting said LED (20) to said battery (44);
said circuit (46) comprising a switch (22) activated by said cover (12), for closing said circuit upon opening said cover (12), and opening said circuit upon closing said cover;
thereby illuminating said strap upon rolling a cigarette.

2. An apparatus according to claim 1, wherein said LED (20) is installed at an edge of said cover, opposite to said pivot (42), in an interior side of said cover, thereby allowing illuminating said strap.

3. An apparatus according to claim 1, wherein said battery is chargeable.

4. An apparatus according to claim 1, further comprising a USB interface, for charging said battery.

5. An apparatus according to claim 1, wherein said circuit (46) is adapted to retain provision of electric power to said LED for a limited period of minutes.

6. A rolling box apparatus, comprising:
a cover (12) pivotally connected to a box (10) thereof by a pivot (42);
a strap (16), for rolling a cigarette;
a illuminating fixture (20), for illuminating said strap;
an electric power source (44), for providing electric power to said illuminating fixture (20);
a circuit (46), for connecting said illuminating fixture (20) to said power source (44);
wherein said circuit comprises a switch (22) activated by said cover (12), for closing said circuit upon opening said cover (12), and opening said circuit upon closing said cover;
thereby illuminating said strap upon rolling a cigarette.

7. An apparatus according to claim 6, wherein said illuminating fixture (20) is installed at an edge of said cover, opposite to said pivot (42), in an interior side of said cover, thereby allowing illuminating of said strap.

8. An apparatus according to claim 6, wherein said illuminating fixture is a LED.

9. An apparatus according to claim 6, wherein said power source is a battery.

10. An apparatus according to claim 6, wherein said power source is chargeable.

11. An apparatus according to claim, further comprising a USB interface, for charging said battery.

12. A handheld rolling box apparatus, comprising:
a cover (12);
a box (10);
a strap (16), for rolling a cigarette;
a illuminating fixture (20), for illuminating said strap;
an electric power source (44), for providing electric power to said illuminating fixture (20);
a circuit (46), for connecting said illuminating fixture (20) to said power source (44);
wherein said circuit comprises a button (48) for activating said circuit to provide electric power to said illuminating fixture;
thereby illuminating said strap upon rolling a cigarette.

13. An apparatus according to claim 12, wherein said circuit is adapted to retain said power provision for a determined period.

14. An apparatus according to claim 12, wherein said button opens said cover.
